(19) United States
(12) Patent Application Publication
(10) Pub. No.: US 2007/0172714 A1
(43) Pub. Date: Jul. 26, 2007

(54) Fuel cell power generating apparatus

(75) Inventors: Kazunori Tsuchino, Tokyo (JP); Kazuhiko Kawajiri, Tokyo (JP); Mitsugu Takahashi, Tokyo (JP); Yoshiaki Odai, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/483,666

(22) Filed: Jul. 11, 2006

(30) Foreign Application Priority Data
Jan. 23, 2006 (JP) 2006-013594

(51) Int. Cl. H01M 8/04

(52) U.S. Cl. 429/34; 429/22

(57) ABSTRACT

A fuel cell power generating apparatus includes a fuel cell that generates electric power by an electrochemical reaction between a fuel gas and an oxidizer gas; a fuel gas generating section connected to the fuel cell and generating the fuel gas; a raw fuel supply line that supplies a raw fuel to the fuel gas generating section; opening/closing sections that discharge a liquid raw material that is part of the raw fuel to the raw fuel supply line; a pressure section that feeds the liquid raw material to the opening/closing sections; and a control section controlling the opening/closing sections by sequentially transmitting pulse-like open signals at shifted times to respective opening/closing sections.

### BACKGROUND OF THE INVENTION

1. Field of the Invention

The present invention relates to a fuel cell power generating apparatus having a fuel gas generating portion and, more particularly, to a fuel cell generating apparatus having an opening/closing section adapted to supply a fuel gas generating portion with a raw fuel including a liquid raw material.

2. Description of the Related Art

In a related fuel cell power generating apparatus having a fuel gas generating portion, a raw fuel including a liquid raw material, such as kerosene and water, is supplied to the fuel gas generating portion. This fuel gas generating portion generates a fuel gas containing hydrogen from the raw fuel. This fuel gas is supplied to a fuel cell to thereby generate electric power. In such a fuel cell power generating apparatus, it is necessary to precisely control the flow rate of a liquid raw material according to the load condition of the fuel cell. The related fuel cell power generating apparatus is provided with a variable flow pump and a flowmeter and employs a method of adjusting the flow rate of the liquid raw material by feedback control. Additionally, a method of using an injector, which is used for fuel injection in an automotive engine, as an section of supplying a liquid raw material is disclosed as a method of a configuration which is simpler than that of the method using the variable flow pump and the flowmeter (see, for example, JP-A-2002-246047 (page 3, FIG. 3)).

Usually, it is supposed that an injector used for fuel injection in an engine provides high lubricity liquid (for instance, gasoline). Thus, in a case where the injector provides low lubricity liquid such as water, the lifetime and the reliability of the injector may be reduced. Incidentally, the lifetime and the reliability of the injector depend upon the number of times of operating the injector and upon the adhesion of foreign substances to a nozzle portion thereof. Assuming that a household fuel cell power generating apparatus is operated at an operation rate of 50% for 10 years, the lifetime of the household fuel cell power generating apparatus is estimated to be about 40,000 hours. However, because the number of available times of operations of the injector is several hundred of millions, the lifetime of the injector is about 5,000 hours. Accordingly, the fuel cell power generating apparatus needs the periodic replacement of the injector. However, assuming that the household fuel cell power generating apparatus is used, maintenance operations, such as the replacement of the injector, need skilled workers. Thus, the related fuel cell power generating apparatus has problems with the cost and the operation thereof. Therefore, a maintenance-free fuel cell power generating apparatus is desired.

As described above, the lifetime of the injector depends upon the number of times of operations thereof. Thus, it is preferable for realizing a longer lifetime to reduce the drive frequency of the injector. However, when the drive frequency is reduced, the amount of liquid injected once from the nozzle is increased. Also, an idle time of the injector, during which the injector injects no liquid, is increased. Therefore, the pulsation of the flow rate is increased. Consequently, the related fuel cell power generating apparatus has a problem in that the drive frequency of the injector cannot be reduced by a necessary amount. A method of providing two or more injectors in the apparatus has been considered as a method of increasing the lifetime of the injector without reducing the drive frequency thereof. However, when only the number of injectors is increased, the lifetime of each of the injectors is multiplied only by a ratio of a total of the number of initial injectors and the number of increased ones to the number of the initial injectors. Thus, the related fuel cell power generating apparatus has a problem in that significant improvement of reliability cannot be achieved.

### SUMMARY OF THE INVENTION

The invention provides a fuel cell power generating apparatus enabled to perform, when a liquid raw material is injected by using a plurality of opening/closing sections, fuel injection without a pulsation, and also enabled to significantly improve the reliability thereof.

According to an aspect of the present invention, a fuel cell power generating apparatus includes: a fuel cell that generates electric power by an electrochemical reaction between a fuel gas and an oxidizer gas; a fuel gas generating section that is connected to the fuel cell and that generates the fuel gas; a raw fuel supply line that supplies the raw fuel to the fuel gas generating section; a plurality of opening/closing sections that discharge a liquid raw material to the raw fuel supply line, the liquid raw material being a part of the raw fuel; a pressure section that liquid-feeds the liquid raw material to the plurality of opening/closing sections; and a control section that is connected to the plurality of opening/closing sections and that sequentially transmits pulse-like open signals at shifted times to the plurality of opening/closing sections, respectively.

According to the invention, pulse-like open signals are sequentially and respectively transmitted at shifted times to a plurality of opening/closing sections adapted to discharge a liquid raw material. Thus, the liquid raw material can be injected without causing a pulsation. Also, the drive frequencies of the individual opening/closing sections are reduced. Consequently, the number of operating the individual opening/closing sections is small. Also, the frequency of adhesion of foreign substances to the opening/closing sections is reduced. Consequently, the significant improvement of the reliability can be achieved.

### BRIEF DESCRIPTION OF THE DRAWINGS

FIG. 1 is a schematic diagram illustrating a fuel cell power generating apparatus according to a first embodiment of the invention;

FIGS. 2A and 2B are graphs illustrating the characteristics of an opening/closing section according to the first embodiment of the invention;

FIG. 3 is an explanatory chart illustrating a control method for n of the opening/closing sections according to the first embodiment of the invention;

FIG. 4 is a graph illustrating the characteristic of the opening/closing section according to the first embodiment of the invention;

FIG. 5 is an explanatory chart illustrating the opening/closing section according to the first embodiment of the invention;

FIGS. 6A, 6B, and 6C are schematic diagrams illustrating the configuration of a pressure section according to the first embodiment of the invention;

FIGS. 7A and 7B are explanatory charts illustrating a control method for four opening/closing sections according to a second embodiment of the invention; and

FIG. 8 is an explanatory chart illustrating a control method for n opening/closing sections according to a third embodiment of the invention.

### DETAILED DESCRIPTION OF THE INVENTION

### FIRST EMBODIMENT

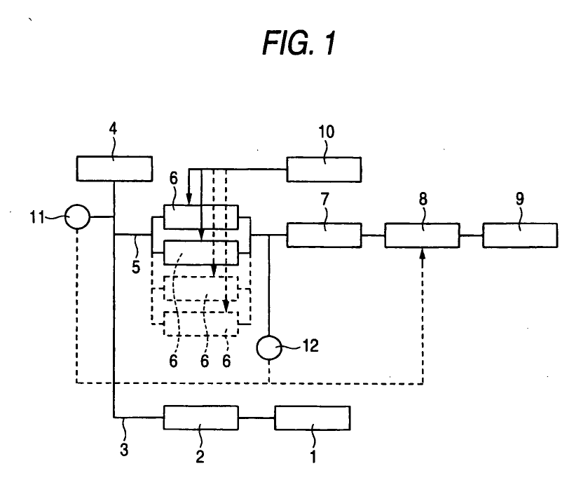

FIG. 1 is a schematic diagram illustrating the configuration of a fuel cell power generating apparatus according to a first embodiment for implementing the invention. As shown in FIG. 1, a fuel gas generating portion 2 is connected to a fuel cell 1. A fuel gas is supplied from the fuel gas generating portion 2 to the fuel gas 1. A raw fuel supply line 3 adapted to supply a raw fuel is connected to the fuel gas generating portion 2 at an end thereof. A raw material supply section 4 is connected to the other end of the raw fuel supply line 3. Also, an oxidizer supply section adapted to supply an oxidizer gas is connected to the fuel cell 1. However, the description of the oxidizer supply section is omitted herein. Also, n parallel-connected opening/closing sections 6 are connected to a middle portion of the raw material supply line 3 through a liquid sending pipe 5. A pressure section 8 is connected to the opening/closing sections 6 through a filter 7. A tank 9 storing raw material water, which is a liquid raw material, is connected to the pressure section 8. The raw material water stored in the tank 9 is injected to the raw fuel supply line 3 from the opening/closing sections 6 through the liquid sending pipe 5 by the pressure section 8. A control section 10 is connected to the n opening/closing sections 6. The control section 10 controls the opening/closing of the opening/closing sections 6. A pressure measurement section 11 is provided on the raw fuel supply line 3 between the liquid sending pipe 5 and the raw material supply section 4. A pressure measurement section 12 is provided on the piping between the filter 7 and each of the opening/closing sections 6.

For example, a blower adapted to boost the pressure of city gas and to discharge the boosted gas may be used as the raw material supply section 4. Also, an injector for fuel injection in an automotive engine may be used as the opening/closing section 6. Pressure sensors may be used as the pressure measurement sections 11 and 12. Also, a microcomputer or a sequencer may be used as the control section 10.

Next, an operation of a fuel cell power generating apparatus according to this embodiment is described below. The pressure of the raw material water stored in the tank 9 is boosted by the pressure section 8 so that the difference in pressure between the pressure measurement sections 11 and 12 (that is, (the pressure at the pressure measurement section 11)−(the pressure at the pressure measurement section 12)) is constant. For example, in a case where the secondary pressure of the opening/closing section 6 (the pressure measured at the pressure measurement section 11) is 0.2 kgf/cm², the primary pressure of the opening/closing section 6 is increased to 0.5 kg/cm² through the control section 10 so that the difference in pressure between the primary pressure (the pressure at the pressure measurement section 12) of the opening/closing section 6 and the secondary pressure thereof is 0.3 kgf/cm². At that time, the flow rate of the raw material water per kW of generated electric power is equal to or less than about 15 cc/min and is low. Thus, there is little pressure loss in the liquid sending pipe 5.

The raw material water discharged from the opening/closing section 6 flows out to the raw fuel supply line 3 through the liquid sending pipe 5. The raw material water having flown out to the raw fuel supply line 3 joins with city gas, which is a raw material flowing in the raw fuel supply line 3, to thereby produce a raw fuel that is a mixture of the raw material and the raw material water. This raw fuel is sent to the fuel gas generating portion 2. A fuel gas containing hydrogen is generated from the raw fuel, which is a mixture of the city gas and the raw material water, in the fuel gas generating portion 2 by a steam reforming reaction. The fuel gas is supplied to the anode of the fuel cell 1, while the oxidizer gas is supplied to the cathode thereof. Thus, electric power is performed by utilizing an electrochemical reaction therebetween.

When the raw material and the raw material water are uniformly mixed in the raw fuel supply line 3, a pulsation, that is, a variation in pressure occurs. Also, a variation in steam-carbon ratio (the molar ratio between the raw material and the raw material water) occurs. This results in variation in the pressure and the composition ratio of the fuel gas generated in the fuel gas generating portion 2. An operation of opening the opening/closing section 6 is performed in response to a rectangular analog pulse electrical signal. Thus, the opening/closing section 6 discharges raw material water. Therefore, when an operation of closing the opening/closing section 6 is performed, the section 6 does not discharge raw material water. Consequently, a pulsation may occur.

It is preferable for preventing occurrence of this phenomenon to operate the opening/closing section at a high frequency. That is, the pulsation can be suppressed by reducing each closing-operation time (hereunder referred to as a pulse-off time) of the opening/closing section. Usually, the flow rate of the raw material water per kW of electric power generated by a fuel cell is equal to or less than about 15 cc/min and is low. Thus, there is limitation on increase in the drive frequency of the opening/closing section. Also, the lifetime of the opening/closing section depends upon the number of times of driving thereof. Therefore, in a case where the opening/closing section is operated at a high frequency, the lifetime thereof is significantly reduced. For example, the responsibility of the injector used as the opening/closing section changes due to the wear thereof caused by the mechanical impact and the friction of the raw material against a valve sheet, which is a composing member of the injector. Consequently, the flow rate accuracy of the section is reduced. Also, fine particles, which cannot be removed by the filter and are contained in the raw material water, are accumulated in a nozzle portion and the valve sheet of the injector used as the opening/closing section. This may reduce the flow rate accuracy. A method of reducing the difference between the primary pressure and the secondary pressure of the opening/closing section is effective as a method of reducing the pulse-off time of the opening/closing section. However, the flow rate accuracy is reduced due to variation in the secondary pressure. When the primary pressure of the opening/closing section is reduced to a low level, the liquid cannot be discharged therefrom.

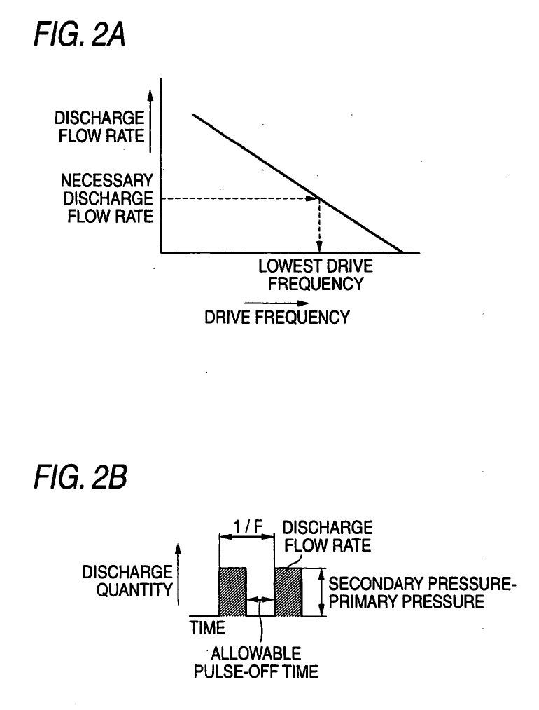

Hereinafter, the case of discharging the raw material, which is in a liquid state, is described. FIGS. 2A and 2B are characteristic graphs illustrating the relation between the drive frequency and the discharge flow rate of the opening/closing section. As illustrated in FIG. 2B, when the raw material water is discharged so that the discharge flow rate changes like a pulse, the discharge flow rate is determined by the difference between the secondary pressure and the primary pressure and a discharge pulse duration. A time between discharge pulses, in which no raw material water is discharged, is set to be a pulse-off time. In a case where the pulse-off time is long, a pulsation occurs. Therefore, it is necessary to reduce the pulse-off time to a value at which the pulsation is allowed. Consequently, an allowable pulse-off time is determined corresponding to the pulsation. Then, the difference between the primary pressure and the secondary pressure of the opening/closing section is determined in response to the variation in the secondary pressure. Also, the flow quantity per unit time is determined. Consequently, a characteristic line representing the relation of the flow rate versus the drive frequency is determined, as illustrated in FIG. 2A. On the other hand, a necessary discharge flow rate of a liquid raw material, which is needed by the fuel cell power generating apparatus, is determined. Thus, a lowest drive frequency shown in FIGS. 2A and 2B is determined.

The number of lifetime years (years) of the opening/closing section is given according to the lifetime, which is represented in terms of the number (times) of times of driving thereof, and an annual operation time of the fuel cell power generating apparatus by dividing the lifetime, which is represented in terms of the number (times) of times of driving the opening/closing section, by [an annual operation time (hours)×the lowest drive frequency (Hz) of the opening/closing section×3600 (seconds)]. The lifetime of the opening/closing section depends upon the kind of the liquid. Especially, in the case of using low lubricity liquid, such as water, in the opening/closing section, it is necessary to design this section by sufficiently taking the safety into consideration. Generally, the number of years obtained by multiplying the target lifetime of the household fuel cell power generating apparatus by (1/n) (n is an optional integer) is set to be the lifetime of a single opening/closing section. Therefore, in a case where the reliability is taken into consideration, it is necessary for the fuel cell power generating apparatus to connect n of the opening/closing sections in parallel. However, according to a method of connecting n of the opening/closing sections in parallel, and using the opening/closing sections individually, and replacing the single opening/closing section with another one when the single opening/closing section almost reaches the lifetime thereof, the lifetime of the entirety of n of the opening/closing sections is simply increased to n-times the original lifetime thereof. However, according to a control method of this embodiment, a long lifetime of the section, which is equal to or more than n-times the original lifetime thereof, can be achieved.

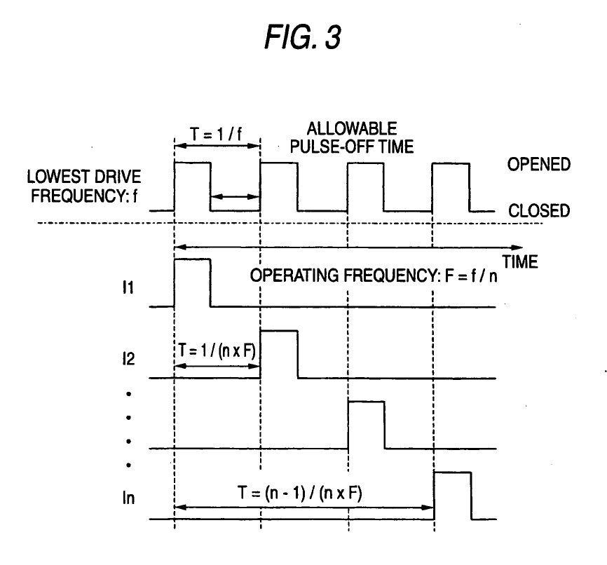

FIG. 3 is an explanatory chart illustrating a method of controlling n of the opening/closing sections (I1, I2 . . . , In (n is an integer that is 1 or more)) according to this embodiment. The drive frequency of each of the opening/closing sections is set to be a frequency F(Hz) that is (1/n)-times the lowest drive frequency f(Hz) obtained by referring to FIGS. 2A and 2B. The opening/closing sections are sequentially and respectively driven at times the adjacent ones of which are shifted by a time that is an inverse of a product of the number n of the opening/closing sections and the driving frequency F thereof. More specifically, open signals are sequentially sent from the control section 10 to the opening/closing sections 6 at times the adjacent ones of which are delayed by a time {1/(n×F)} (seconds). At that time, each of the opening/closing sections 6 is in a closed state when the signal is off. Thus, each of the opening/closing sections 6 receives an open signal that puts a corresponding one of the opening/closing sections 6 into an opened state for a time corresponding to a pulse duration determined by the allowable pulse-off time and the lowest drive frequency.

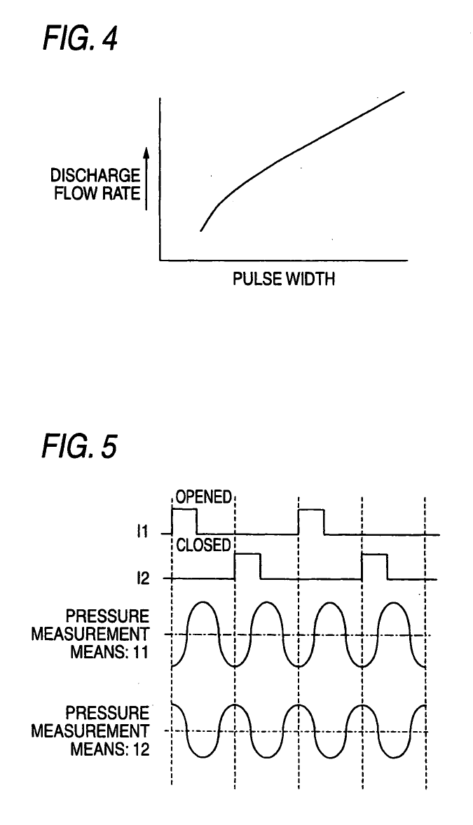

FIG. 4 is a characteristic graph illustrating the relation between the pulse duration and the discharge flow rate of the open signal putting the opening/closing section into an opened state. In a wide range of the pulse duration, the discharge flow rate is proportional to the pulse duration.

FIG. 5 is an explanatory chart illustrating variation in pressure applied to the opening/closing section. For simplicity of description, a apparatus employing two opening/closing sections I1 and I2 is described below. When the opening/closing section I1 is opened in a condition in which the opening/closing section I2 is in a closed state, the pressure measured by the pressure measurement section 11 provided downstream of the opening/closing section I1 gradually increases. As this pressure increases, the pressure measured by the pressure measurement section 12 provided upstream from the opening/closing section I1 gradually decreases. When the opening/closing section I1 is closed, the pressure measured by the pressure measurement section 11 decreases, while the pressure measured by the pressure measurement section 12 increases. When opening/closing section I2 is opened in a condition in which the opening/closing section I1 is in a closed state, a change in the pressure, which is similar to the pressure change caused when the opening/closing section I1 is opened, occurs in each of the pressure measurement sections 11 and 12. At that time, although the opening/closing section I1 maintains the closed state, the opening/closing section I1 undergoes variation in pressure, which is caused by the opening/closing operation of the opening/closing section I2. Even in a case where the single opening/closing section is opened or closed, or where a plurality of the opening/closing sections are simultaneously opened or closed, each of the opening/closing sections undergoes only the variation in the pressure, which is caused by the opening or closing operation of each of the other opening/closing sections. However, according to this embodiment, the plurality of opening/closing sections are opened or closed at shifted times. Thus, even when each of the opening/closing sections is in a closed state, the opening/closing sections constantly undergo the variation in pressure. Consequently, the possibility of accumulation of fine particles, which cannot be removed by the filter from the raw material water, onto the nozzle portion and the valve sheet of the injector used as the opening/closing section is extremely reduced.

Incidentally, it is assumed in this embodiment that the target lifetime of the fuel cell apparatus is 10 years, that the annual operation time of the fuel cell apparatus is 8,000 hours, that the lifetime represented in terms of the number of times of operating the single opening/closing section is three hundred millions, that the allowable pulse-off width is 100 ms, and that the difference between the primary pressure and the secondary pressure of each of the opening/closing sections 6 ranges from 25 kPa to 100 kPa. Then, the lowest drive frequency of each of the opening/closing sections 6 ranges from 5 Hz to 20 Hz. In a case where the difference between the primary pressure and the secondary pressure of each of the opening/closing sections 6 is set in consideration of the power consumption and the lifetime of the pressure section 8 to be 25 kPa, the lowest drive frequency f of each of the opening/closing sections is 5 Hz. At that time, the lifetime of the single opening/closing section is about 2 years (=three hundred millions / [8,000 (hours)×5 (Hz)×3600 (seconds)]). Therefore, to achieve the target lifetime that is 10 years, 5 opening/closing sections are needed (10(years)/2(years)=5). In this case, 5 opening/closing sections are parallel-connected. The drive frequency of each of the opening/closing sections is 1 Hz (=5 (Hz)×⅕). A delay time between the adjacent opening/closing sections is 0.2 seconds (=1/[5×1(Hz)]).

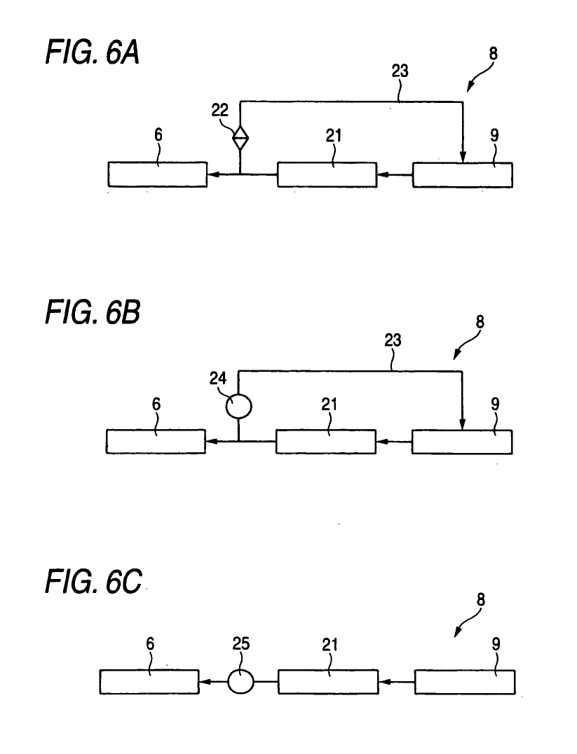

Next, the pressure section 8 in this embodiment is described below in detail. FIGS. 6A to 6C are schematic diagrams illustrating the configuration of the pressure section 8 provided in this first embodiment. Although a filter is connected between the pressure section 8 and the opening/closing section 6, the description of this filter is omitted herein. Although the apparatus is actually provided with a plurality of opening/closing sections 6, only one of the opening/closing sections 6 is shown in FIGS. 6A to 6C. As shown in FIG. 6A, the pressure section 8 includes a booster pump 21, a flow metering valve 22 placed downstream from the booster pump 21, and a return flow line 23 communicating the secondary pressure side of this flow metering valve 22 with the tank 9. The primary pressure of the opening/closing section 6 is adjusted by controlling the flow metering valve 22. When the booster pump 21 is driven by feedback control so that the difference in pressure between the pressure measurement sections 11 and 12, that is, the difference between the primary pressure and the secondary pressure of the opening/closing section 6 is constant, the pressure applied to lines among the opening/closing section 6, the flow metering valve 22, and the booster pump 21 are increased. Surplus raw material water flows backward to the tank 9 through the return flow line 23. The operation of controlling the difference between the primary pressure and the secondary pressure of the opening/closing section 6 to be constant enables the apparatus to deal with an increase in pressure loss due to impurities captured by the filter 7 and to disturbance caused by the variation in the secondary pressure. Also, the difference between the primary pressure and the secondary pressure of the opening/closing section 6 can be reduced. Consequently, the power consumption of the pressure section 8 can be reduced.

As described above, according to this embodiment, the apparatus is configured by taking advantage of the opening/closing section, which can supply the raw material water at low cost with high accuracy, so that n of the opening/closing sections are parallel-connected, that each of the opening/closing sections is driven at the frequency F that is (1/n)-times the lowest drive frequency, and that the opening/closing sections are sequentially and respectively driven at shifted times, the adjacent ones of which are delayed by the inverse of the product of the number n of the opening/closing sections and the driving frequency F thereof. Such a control operation enables of the reduction of the frequency of each of the opening/closing sections to (1/n)-times the lowest drive frequency without causing a pulsation. Also, the flow rate of the raw material water flowing through each of the opening/closing sections can be reduced to (1/n)-times the flow rate of the whole opening/closing sections. Thus, an amount of foreign materials adhering to the nozzle portion of the injector used as the opening/closing section can be reduced. Consequently, the lifetime of the apparatus, which is equal to or more than a value obtained by multiplying the lifetime of the single opening/closing section by the number n of the opening/closing sections (a value that is n-times the lifetime of the single opening/closing section or more) can be ensured. Thus, the raw material water can stably be discharged in a long term. Consequently, a water supply maintenance free apparatus can be realized.

Also, n of the opening/closing sections are parallel-connected to the single pressure section so that the drive frequency of each of the opening/closing sections is made to be (1/n)-times the original drive frequency thereof. Also, although the number of the opening/closing sections is increased, the opening/closing sections are driven at shifted times. Thus, the power consumption of the apparatus does not increase. That is, the opening/closing sections can be driven so that the power consumption thereof is substantially equal to the power consumption of the single opening/closing section.

Incidentally, according to this embodiment, the pressure section includes the booster pump, the flow metering valve, and the return flow line, as shown in FIG. 6A. However, the configuration of the pressure section is not limited thereto. For example, the pressure section may employ a booster pump having a property that the primary pressure of the opening/closing section 6 is constant, that is, a property that when the discharge pressure of the booster pump increases, the flow rate decreases. Also, the pressure section may include the booster pump 21, a backpressure regulator 24 provided downstream from the booster pump 21, and the return flow line 23 communicating the secondary pressure side of the backpressure regulator 24 with the tank 9, as shown in FIG. 6B. With this configuration, the backpressure regulator 24 is set at a pressure that is equal to the primary pressure of the opening/closing section 6. When the booster pump 21 is driven, surplus raw material water can be returned through the return flow line 23 so that the pressure applied on the lines among the opening/closing section 6, the backpressure regulator 24, and the booster pump 21 can maintain a value of the pressure set by the backpressure regulator 24. Alternatively, the pressure section may include the booster pump 21, and an ordinary regulator 25 provided downstream from the booster pump 21, as shown in FIG. 6C. In this case, it is desirable that the booster pump 21 has a property that when the discharge pressure increases to the pressure set by the regulator 25, the flow rate becomes substantially zero. With such a configuration, even when the discharge pressure of the booster pump 21 varies, so that the primary pressure of the regulator 25 varies, the secondary pressure of the regulator 25, that is, the primary pressure of the opening/closing section 6 can be maintained to be nearly constant.

Also, this embodiment is configured so that after the raw material water and the raw material are mixed in the raw fuel supply line 3, the mixture is sent to the fuel gas generating portion 2. However, the apparatus may be configured so that the liquid sending pipe shown in FIG. 1 is directly connected to the fuel gas generating portion 2, that the raw material water is singly sent to the fuel gas generating portion 2, that the raw material water is vaporized in the fuel gas generating portion 2, and that after the raw material water is changed to vapor, the vapor is mixed with the raw material.

Although the pressure measurement section 11 is disposed on the raw fuel supply line 3 in this embodiment, the pressure measurement section 11 may be disposed on the liquid sending pipe 5, as long as the secondary pressure of the opening/closing section 6 can be measured by the pressure measurement section 11.

In the foregoing description, this embodiment has been described so that the city gas is employed as the raw material. However, the raw material is not limited thereto. Materials serving as a hydrogen source, such as carbon hydride and alcohols, may be used as the raw material. For instance, gaseous materials, such as propane and butane, and carbide-based liquid materials, such as kerosene, methanol, and dimethyl ether, may be used. In the case where carbide-based liquid materials are used, the liquid raw material maybe supplied by using the tank, the pressure section, the opening/closing section, and the liquid sending pipe, similarly to the case of using the raw material water.

Also, although the injector, which is used for fuel injection in an automotive engine, is used as the opening/closing section in this embodiment, for example, a direct operated solenoid valve, or a linear control valve used in an air conditioner may be used as the opening/closing section. Incidentally, when these opening/closing sections are used, it is necessary to employ a material, which is resistant to the liquid raw material and the raw material water, as the material of the opening/closing section.

Incidentally, the foregoing description of this embodiment has described the case where the number of the opening/closing sections is 2. Preferably, the number of the opening/closing sections ranges from 2 to 10. More preferably, the number of the opening/closing sections ranges from 4 to 8. The number of the opening/closing sections can appropriately be determined according to the target lifetime of the fuel cell power generating apparatus, the lifetime of the single opening/closing section, and an operation mode of the fuel cell power generating apparatus (for example, a continuous run, or an intermittent run including a shutdown caused periodically every 24 hours).

### SECOND EMBODIMENT

Although the foregoing description of the first embodiment has described the control method for the plurality of opening/closing sections in a rated operation of the fuel cell power generating apparatus, that is, at a certain flow rate of the raw material water, the following description describes a second embodiment configured so that the number of driven opening/closing sections can be changed in response to variation in the flow rate of raw material water according to the load condition of the fuel cell in a fuel cell power generating apparatus of a configuration similar to the configuration of the first embodiment.

To decrease the flow rate of the raw fuel in a low load operation corresponding to the drive frequency of the opening/closing section in the rated operation of the fuel cell power generating apparatus, it is necessary that an amount of a raw material, such as city gas, supplied from the raw material supply section is reduced, and that the pulse duration of an open signal sent to the opening/closing section is narrowed to decrease the flow rate of raw material water, that is, a closed time, in which the opening/closing section is closed, is increased. When this closed time is longer than the allowable pulse-off time, a pulsation occurs. To reduce the pulse duration of the open signal without increasing the closed time, it is necessary to increase the drive frequency. In such a case, the lifetime of the opening/closing section is reduced. The second embodiment is adapted to reduce the flow rate of the raw material water by changing the number of driven opening/closing section to thereby increase the apparent drive frequency of the opening/closing section.

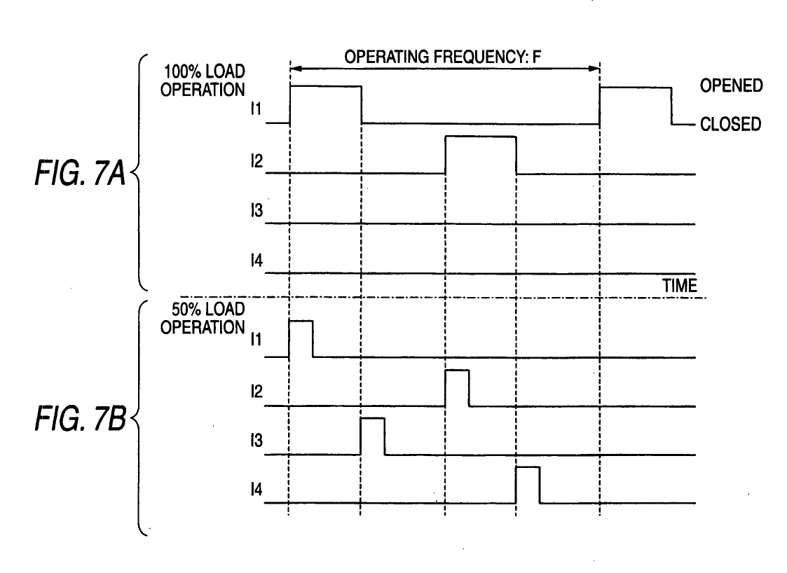

The following description describes a case where four opening/closing sections are parallel-connected, for brevity of description. FIGS. 7A and 7B are an explanatory chart illustrating a control method for the four opening/closing sections in the second embodiment. FIG. 7A illustrates a control method for the opening/closing sections in a rated operation, that is, in a 100% load operation. The raw material water is discharged by driving the two opening/closing sections I1 and I2, among the four opening/closing sections (hereunder designated by I1 to I4). Next, in a 50% load operation, as illustrated in FIG. 7B, all the four opening/closing sections are driven. Also, pulses serving as open signals are sequentially sent to at times, the adjacent ones of which are shifted by a time obtained by an inverse of the product of the number of the opening/closing sections and the driving frequency thereof, by driving all the four opening/closing sections. More specifically, a pulse is sent to the opening/closing section I3 after a time period of 1/[4×F (Hz)] (seconds) has elapsed since a pulse is sent to the opening/closing section I1. Moreover, after the elapse of an equal time period since then, a pulse is sent to the section I2. Furthermore, after the elapse of an equal time period since then, a pulse is sent to the opening/closing section I4. With such a configuration, the pulse-off time in the single opening/closing section is increased. However, on the whole, in the entirety of the four opening/closing section, the discharge interval, at which the raw material water is discharged, is shorter than the discharge interval in the 100% load operation. Consequently, occurrence of a pulsation can be prevented.

Thus, according to this embodiment, plural opening/closing sections are parallel-connected. The number of driven opening/closing sections is changed according to the necessary flow rate of the raw material water. Consequently, even in a case where the flow rate of the raw material water is reduced in the low load operation, occurrence of the pulsation of the raw water material can be prevented. The drive frequency of each of the opening/closing sections can be reduced. Thus, the amount of foreign materials adhering to the nozzle portion of the injector can be reduced.

Consequently, the lifetime of the apparatus, which is equal to or more than a value obtained by multiplying the lifetime of the single opening/closing section by the number of the opening/closing sections, can be ensured. The stable discharge of the raw material water can be achieved for a long term. Consequently, a water supply maintenance free apparatus can be realized.

Incidentally, in this embodiment, pulses are sent to the four opening/closing sections I1 to I4 at uniform intervals of 1/[4×F (Hz)] (seconds) in a low load operation. As long as no pulsation occurs, it is not always necessary to send the pulses at uniform intervals. In a case where the four opening/closing sections are taken as a whole, as long as the discharge interval is shorter than the allowable pulse-off, the pulses may be sent at different intervals. The foregoing description of this embodiment has described an example in which all the opening/closing sections are driven in a low load operation. However, the number of driven opening/closing sections is not limited thereto. The number of driven opening/closing sections may be sequentially changed according to the rate of the load operation. Also, the foregoing description of this embodiment has described an example in which the opening/closing sections I1 and I2 are driven in a 100% load operation. However, the apparatus may be configured so that the driven opening/closing sections are not fixed, and that the driven opening/closing sections are appropriately changed. Such a control operation enables that the numbers of times of driving the plurality of opening/closing sections are made to be uniform. Consequently, the reliability of the entirety of the opening/closing sections can be enhanced.

### THIRD EMBODIMENT

At least two opening/closing sections are always driven in the first and second embodiments. However, the following description of a third embodiment describes a control method according to which only one opening/closing section is always driven. The configuration of the fuel cell power generating apparatus according to this embodiment is similar to that of the apparatus according to the first embodiment.

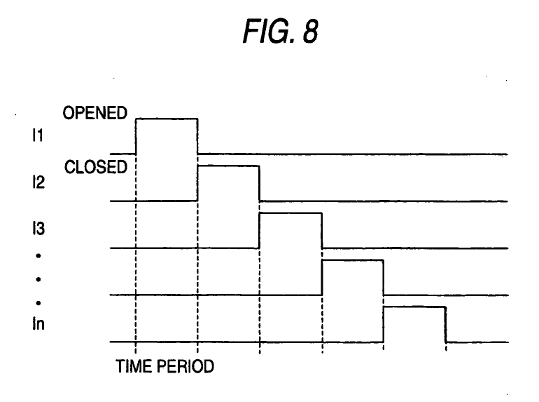

FIG. 8 is an explanatory chart illustrating the control method for n of the opening/closing sections according to this embodiment. Among the n opening/closing sections, only one of the opening/closing sections is driven at a time every moment. For example, the single opening/closing section I1 is driven for a certain time, during which the other opening/closing sections I2 to In are stopped. Incidentally, the drive time of the single opening/closing section is set to be 1 day to 7 days. The opening/closing section to be driven is used by serially being changed among the n opening/closing sections I1 to In.

According to such a control method, the lifetime of each of the opening/closing sections can be increased, as compared with the method of driving the n opening/closing sections one by one and replacing one of the opening/closing section when this driven opening/closing section reaches the lifetime. This is because an opening/closing section stopped in a condition, in which the opening/closing section having been exposed to the raw material water without being driven for a long term (for example, several years), is inferior in the reliability to the opening/closing sections driven every predetermined time period. Thus, it may be impossible to simply increase the lifetime of the opening/closing sections to n-times the lifetime of the single opening/closing section. However, in a case where each of the opening/closing sections is driven every predetermined time period, the reliability of the opening/closing sections can be ensured. The lifetime of the opening/closing sections can surely be increased to n-times the lifetime of the single opening/closing section.

Incidentally, the description of this embodiment has described the case where only one of the opening/closing sections is driven at a time every moment. However, the number of the opening/closing sections to be driven at a time every moment is not limited to 1. The apparatus may employ a method adapted so that the n opening/closing sections are divided into a plurality of sets, that in each of the sets, the opening/closing sections are driven similarly to the first embodiment, and that the driven set of the opening/closing sections is serially changed to another of the sets every predetermined time period. According to this method, the lifetime of the opening/closing sections can surely be increased to n-times the lifetime of the single opening/closing section or more.

1. A fuel cell power generating apparatus comprising:
a fuel cell that generates electric power by an electrochemical reaction between a fuel gas and an oxidizer gas;
a fuel gas generating section that is connected to the fuel cell and that generates the fuel gas;
a raw fuel supply line that supplies a raw fuel to the fuel gas generating section;
a plurality of opening/closing sections that discharge a liquid raw material to the raw fuel supply line, the liquid raw material being a part of the raw fuel;
a pressure section that feeds, as a liquid, the liquid raw material to the plurality of opening/closing sections; and
a control section that is connected to and controls the plurality of opening/closing sections by sequentially transmitting pulse-like open signals at shifted times to respective opening/closing sections.

2. The fuel cell power generating apparatus according to claim 1, wherein the opening/closing sections are injectors.

3. The fuel cell power generating apparatus according to claim 1, wherein the control section transmits the pulse-like open signals to respective opening/closing sections at times, an adjoining one of which is shifted by a time corresponding to an inverse of a product of the number of the opening/closing sections and operating frequency of the pulse-like open signals.

4. The fuel cell power generating apparatus according to claim 1, wherein one of the pulse-like open signals is transmitted to a part of the plurality of opening/closing sections.

5. The fuel cell power generating apparatus according to claim 1, wherein operating frequency of the pulse-like open signals ranges from 5 Hz to 20 Hz.
